(19) United States
(12) Patent Application Publication
(10) Pub. No.: US 2025/0016530 A1
(43) Pub. Date: Jan. 9, 2025

(54) SYSTEMS AND METHODS FOR PROVIDING NUMBERS-AS-A-PLATFORM SERVICES

(71) Applicant: Verizon Patent and Licensing Inc., Basking Ridge, NJ (US)

(72) Inventors: Andrew Roger KATSIKAPES, Port Hadlock, WA (US); Zachary DROSSMAN, New York, NY (US); Christian GUIRNALDA, Cranbury, NJ (US); Courtney SNAVELY, Culver City, CA (US)

(73) Assignee: Verizon Patent and Licensing Inc., Basking Ridge, NJ (US)

(21) Appl. No.: 18/348,062

(22) Filed: Jul. 6, 2023

(51) Int. Cl. H04W 4/16

(52) U.S. Cl. CPC H04W 4/16

(57) ABSTRACT

A device may receive an identifier for a user of multiple clients, and may receive configurations for multiple applications via an agnostic interface and software development kits. The device may associate the identifier with the multiple clients and the multiple applications, and may configure, based on the configurations, the multiple applications for utilization of services associated with the identifier. The device may receive respective activity times associated with the multiple clients' utilizations of the multiple applications, and may receive a notification destined for the identifier. The device may utilize an activity service, of the services, to rank the multiple clients based on the respective activity times and to generate a ranked list. The device may identify one or more of the multiple clients based on the ranked list, and may provide the notification to the one or more of the multiple clients.

### BACKGROUND

Currently, a user of multiple clients (e.g., user devices) may be associated with a single identifier (e.g., a telephone number) and may be identified via the single identifier when utilizing one of the multiple clients.

### BRIEF DESCRIPTION OF THE DRAWINGS

FIGS. 1A-1I are diagrams of an example associated with providing numbers-as-a-platform services.

FIG. 2 is a diagram of an example environment in which systems and/or methods described herein may be implemented.

FIG. 3 is a diagram of example components of one or more devices of FIG. 2.

FIG. 4 is a flowchart of an example process for providing numbers-as-a-platform services.

### DETAILED DESCRIPTION OF EXAMPLE EMBODIMENTS

The following detailed description of example implementations refers to the accompanying drawings. The same reference numbers in different drawings may identify the same or similar elements.

Multiple clients associated with a single user identifier may access different applications (e.g., application servers) with the single user identifier and may utilize the applications to perform a function (e.g., make a telephone call, receive a telephone call, and/or the like). However, there is a one-to-one connection between a client and the application server (e.g., via a gateway component). Such an architecture poses a constraint on scalability of the architecture since the gateway component has a limited scale which is determined by peak call volume associated with individual entities (e.g., application providers) associated with gateway components (e.g., the architecture is limited to one client per gateway component). Thus, current techniques for using single user identifier to access different applications consume computing resources (e.g., processing resources, memory resources, communication resources, and/or the like), networking resources, and/or other resources associated with failing to connect a call with the single user identifier and via an application, failing to scale the single user identifier to provide additional services via the applications, failing to connect multiple clients to an application via the single user identifier, and/or the like.

Some implementations described herein provide a service system that provides numbers-as-a-platform services. The service system may utilize a user's telephone number as an identifier to authenticate a client (e.g., a user device) with a telecommunications network, and may enable the client to perform activities (e.g., calling, messaging, and/or the like) typically associated with a voice-over-Internet protocol (VOIP) endpoint device. For example, the service system may receive an identifier for a user of multiple clients, and may receive configurations for multiple applications via an agnostic interface and software development kits. The service system may associate the identifier with the multiple clients and the multiple applications, and may configure, based on the configurations, the multiple applications for utilization of one or more services associated with the identifier to generate multiple configured applications. The service system may receive respective activity times associated with the multiple clients' utilizations of the multiple applications, and may receive a notification destined for the identifier. The service system may utilize an activity service, of the one or more services, to rank the multiple clients based on the respective activity times and to generate a ranked list. The service system may identify one or more of the multiple clients based on the ranked list, and may provide the notification to the one or more of the multiple clients.

In this way, the service system provides numbers-as-a-platform services. For example, the service system may provide a set of agnostic public application programming interfaces (APIs) that enable application developers tools to allow users of clients to link user identifiers (e.g., telephone numbers) to applications (e.g., applications that can make and receive calls to a telephone number). The service system may change traditional calling since telephone numbers are no longer tied to a personal phone and may enable application developers to integrate native calling into applications. The service system may enable application developers to use telephone numbers in new and creative ways. Thus, the service system may conserve computing resources, networking resources, and/or other resources that would have otherwise been consumed by failing to connect a call with the single user identifier and via an application, failing to scale the single user identifier to provide additional services via the applications, failing to connect multiple clients to an application via the single user identifier, and/or the like.

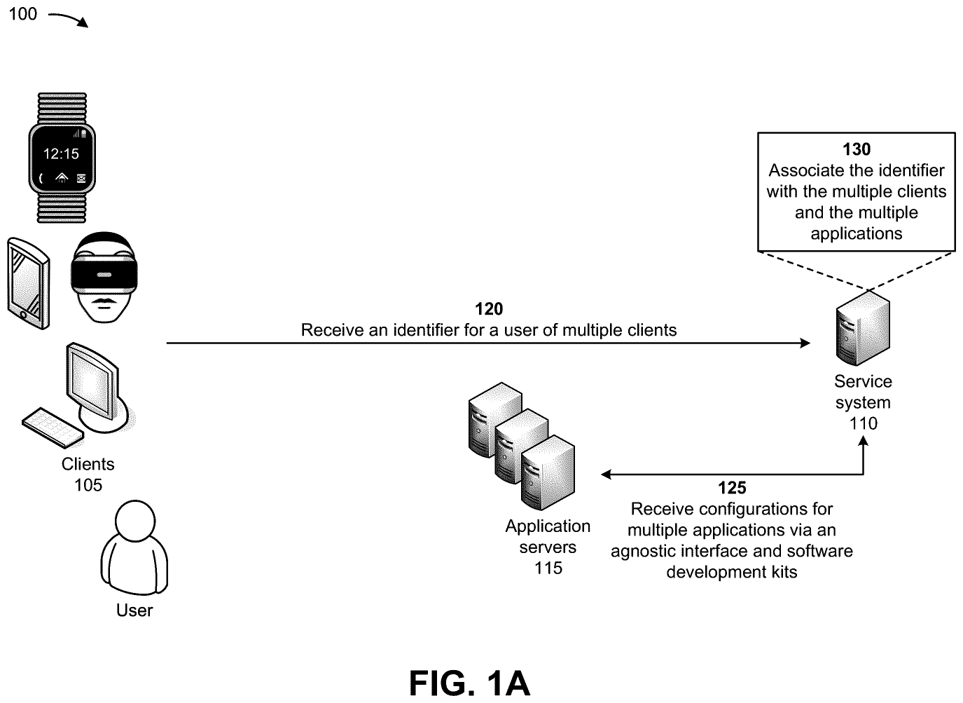

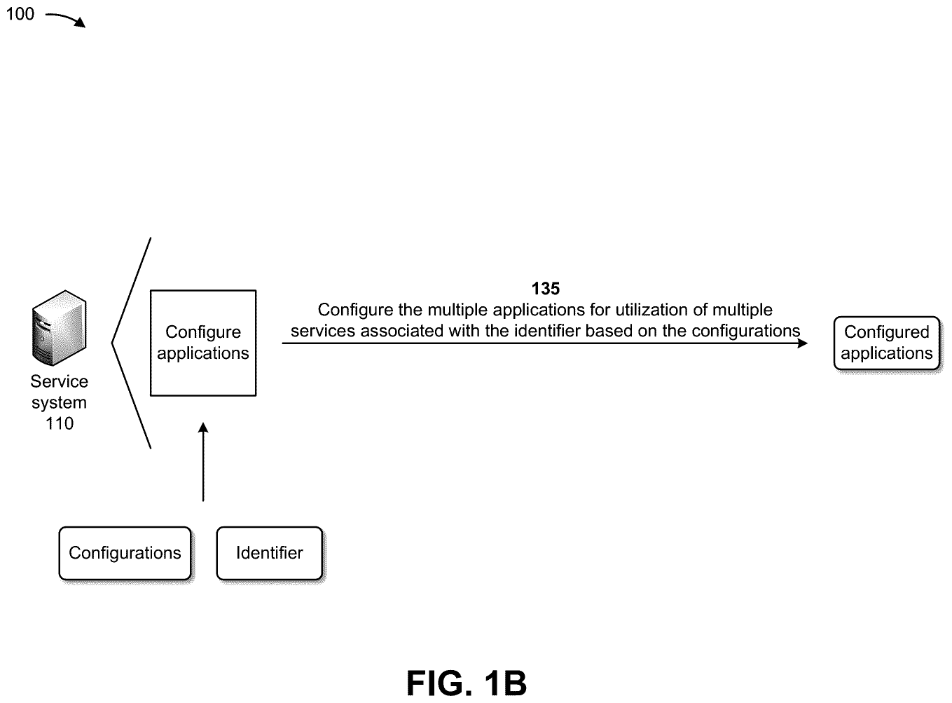

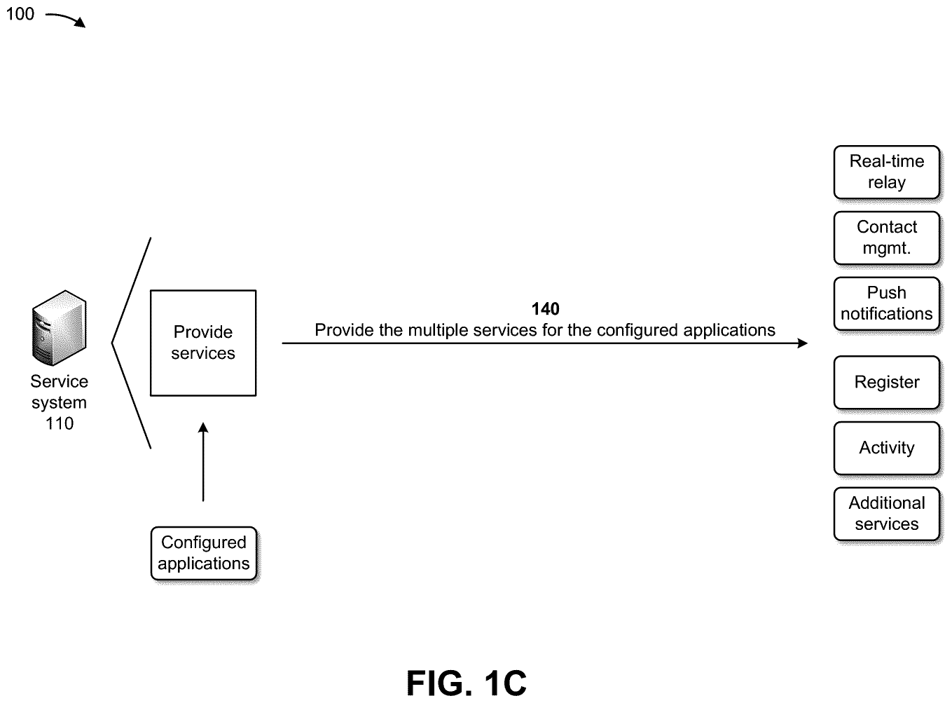

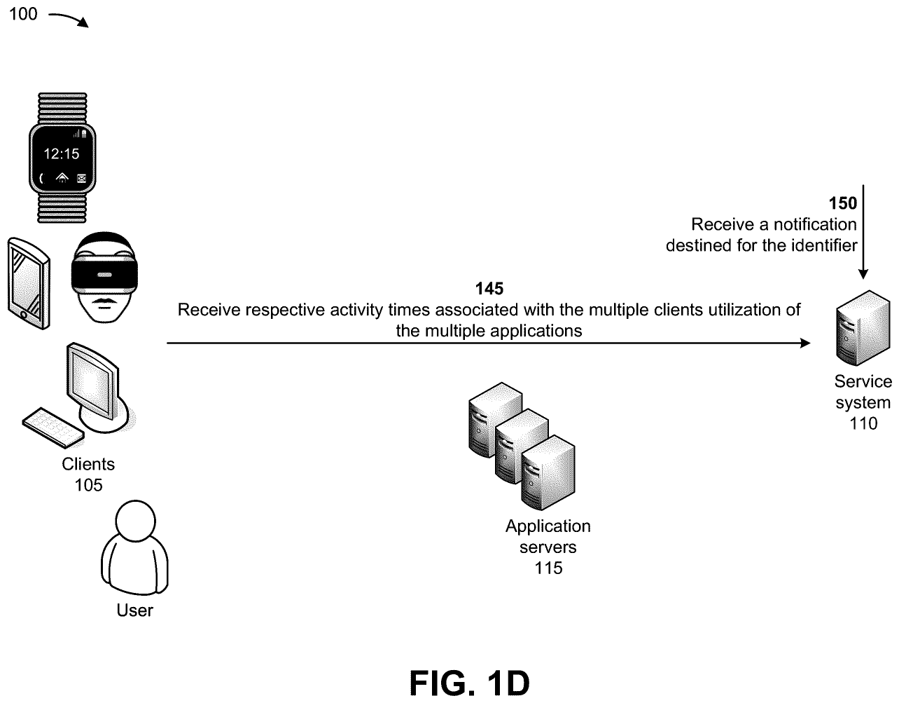

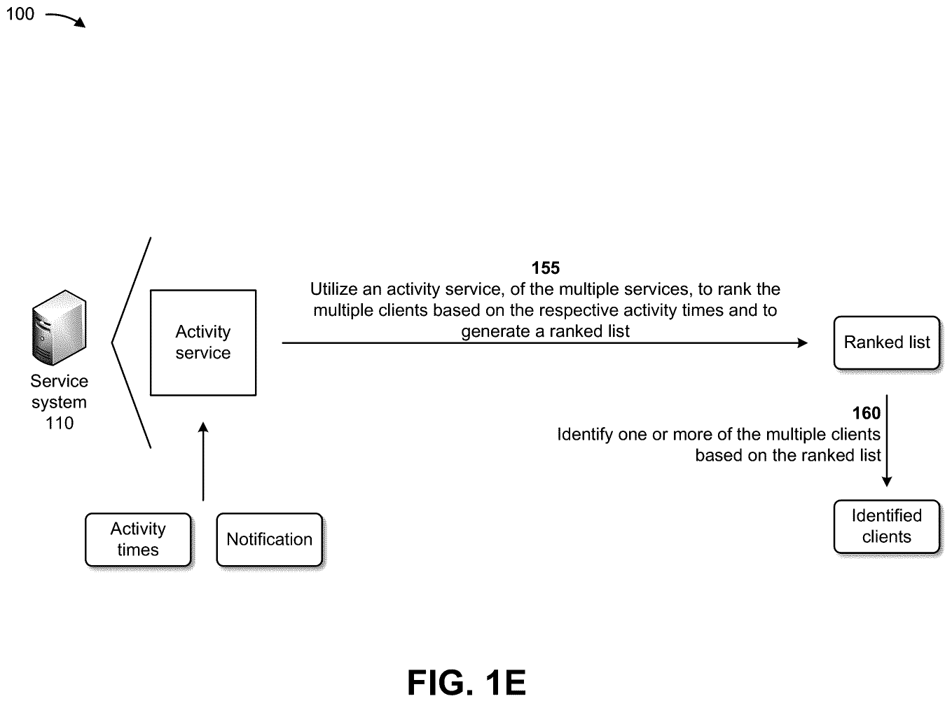

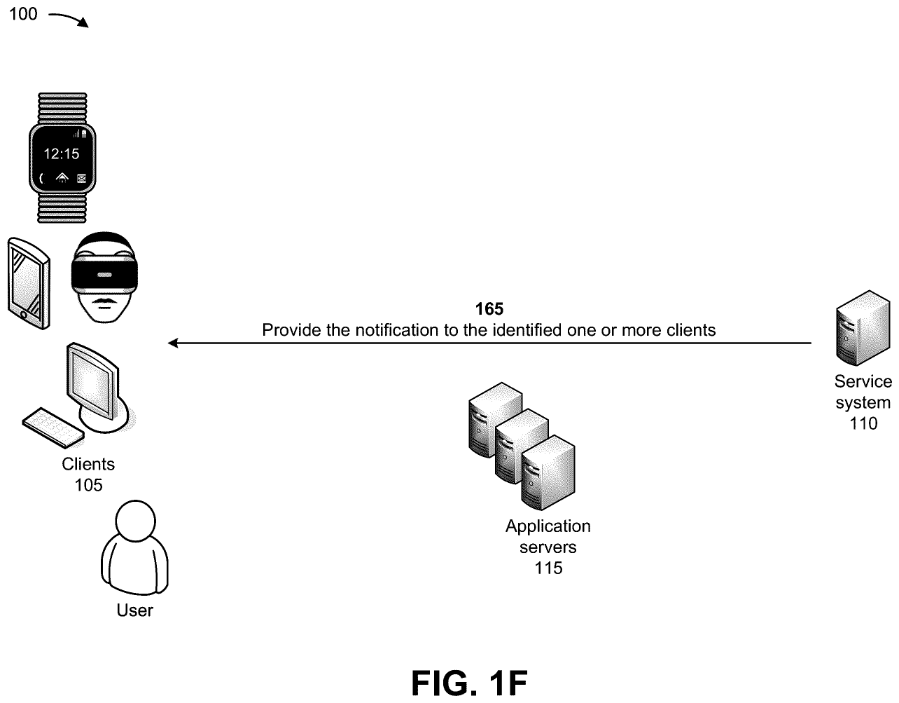

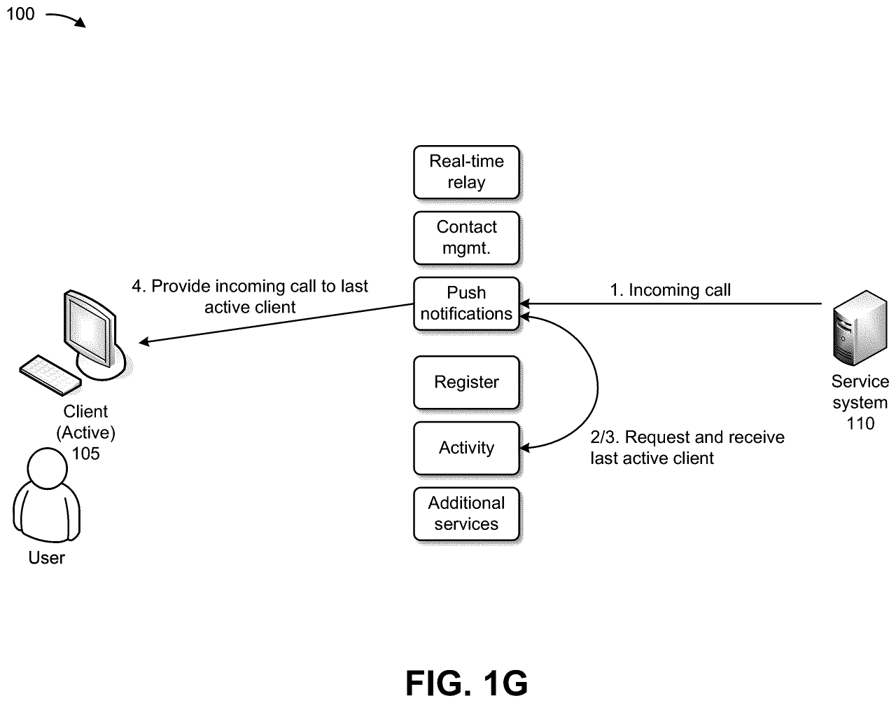

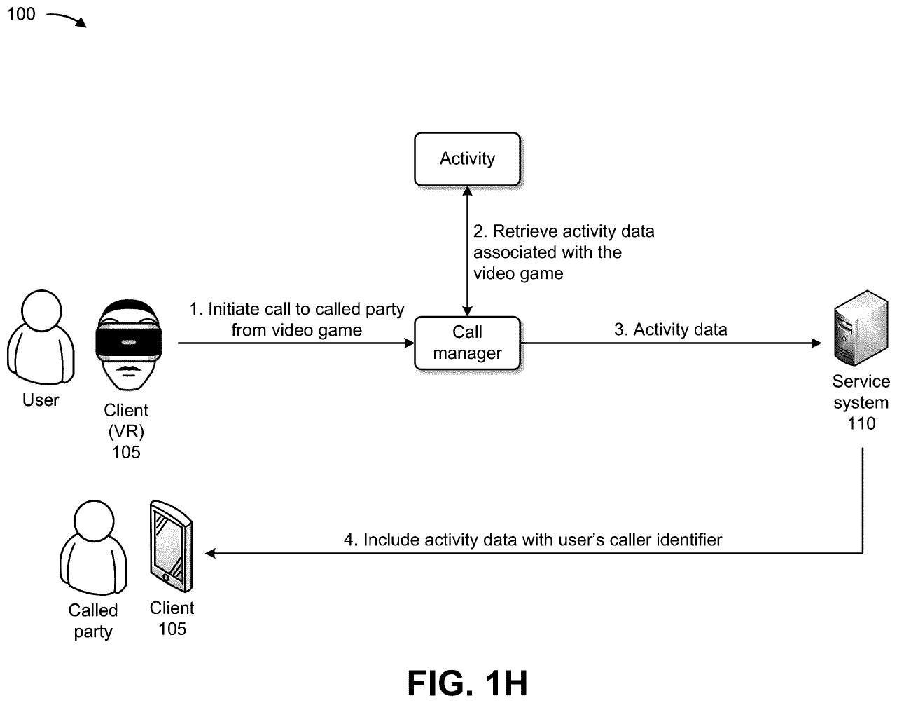

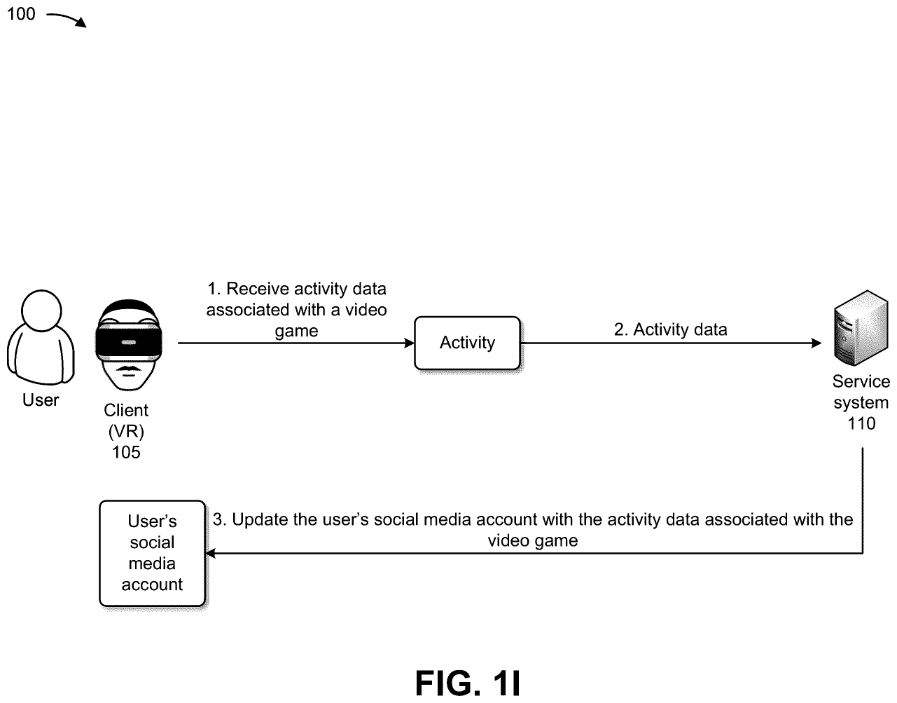

FIGS. 1A-1I are diagrams of an example 100 associated with providing numbers-as-a-platform services. As shown in FIGS. 1A-1I, example 100 includes multiple clients 105 associated with a service system 110 and multiple application servers 115. Further details of the clients 105, the service system 110, and the application servers 115 are provided elsewhere herein.

As shown in FIG. 1A, and by reference number 120, the service system 110 may receive an identifier for a user of the multiple clients 105. For example, the user of the multiple clients 105 may be associated with the identifier (e.g., a telephone number, a username, an account identifier, and/or the like). The identifier may enable the user to utilize one or more of the multiple clients 105 to perform a function, such as placing a telephone call, receiving a telephone call, transmitting a text message, receiving a text message, and/or the like. In some implementations, the service system 110 may receive the identifier for the user from one of the multiple clients 105, may receive the identifier for the user based on establishing an account for the user with the service system 110, and/or the like.

As further shown in FIG. 1A, and by reference number 125, the service system 110 may receive configurations for multiple applications via an agnostic interface and software development kits. For example, the service system 110 may be associated with the application servers 115. The application servers 115 may provide the multiple applications for the multiple clients 105. The multiple applications may include a social media application, a video game application, a telephone call application, a text messaging application, a health tracking application, a virtual reality application, an augmented reality application, and/or the like. The multiple applications may be modified to enable the multiple clients 105 to perform a function (e.g., placing a telephone call, receiving a telephone call, transmitting a text message, receiving a text message, and/or the like) via the multiple applications.

Developers of the applications may utilize software development kits to modify the multiple applications. The software development kits may provide user interfaces that are compatible with the application servers 115 so that the application developers may modify the multiple applications. The service system 110 may also provide an agnostic interface (e.g., an agnostic application programming interface (API) or an agnostic API server) that is capable of communicating with each of the application servers 115 (e.g., despite the application servers 115 being configured and including different front ends). The service system 110 may receive, from the application servers 115, the configurations for the multiple applications via the agnostic interface and the software development kits. The configurations may configure the multiple applications to enable the multiple clients 105 to perform the function (e.g., placing a telephone call, receiving a telephone call, transmitting a text message, receiving a text message, and/or the like) via the multiple applications. In some implementations, the service system 110 may receive the configurations and may utilize the configurations to configure the multiple applications to enable the multiple clients 105 to perform the function via the multiple applications.

As further shown in FIG. 1A, and by reference number 130, the service system 110 may associate the identifier with the multiple clients 105 and the multiple applications. For example, since the user may utilize the multiple clients 105 and the multiple applications, the service system 110 may associate the user with the multiple clients 105 and the multiple applications. In some implementations, the service system 110 may associate the user with the multiple clients 105 and the multiple applications by associating the identifier with the multiple clients 105 and the multiple applications. The identifier may enable the multiple clients 105 to perform the function (e.g., placing a telephone call, receiving a telephone call, transmitting a text message, receiving a text message, and/or the like) via the multiple applications.

As shown in FIG. 1B, and by reference number 135, the service system 110 may configure the multiple applications for utilization of multiple services associated with the identifier based on the configurations. For example, the service system 110 may provide multiple services associated with the identifier (e.g., an activity service, an authentication service, a real-time relay service, a contact management service, a push notification service, a register service, and/or the like, as described below in connection with FIG. 1C). The service system 110 may utilize the configurations to configure the multiple applications (e.g., to generate multiple configured applications) to enable the multiple clients 105 to utilize the multiple services via the multiple applications.

As shown in FIG. 1C, and by reference number 140, the service system 110 may provide the multiple services for the configured applications. For example, the service system 110 may provide the multiple services associated with the identifier for the multiple configured applications. The multiple services may include an activity service, an authentication service, a real-time relay service, a contact management service, a push notification service, a register service, and additional services (e.g., a call manager service). The activity service may include a service that monitors respective activity times associated with the multiple clients 105 and/or the multiple applications, and that utilizes the activity times when performing the function (e.g., placing a telephone call, receiving a telephone call, transmitting a text message, receiving a text message, and/or the like) via the multiple applications. Further details of the activity service are provided below in connection with FIGS. 1D-1I.

The authentication service may include a service that authenticates the user, the identifier, the multiple clients 105, the multiple application servers 115, the multiple applications, and/or the like. The real-time relay service may include a service that enables persons with hearing or speech disabilities to place and receive telephone calls. The contact management service may include a service that manages contacts (e.g., telephone contacts, social media contacts, text messaging contacts, and/or the like) associated with the user. The push notification service may include a service that provides push notifications (e.g., call notifications, text message notifications, social media notifications, and/or the like) to the user via the multiple clients 105. Further details of the push notifications service are provided below in connection with FIG. 1G. The register service may include a service that registers the user, the identifier, the multiple clients 105, the multiple application servers 115, the multiple applications, and/or the like with the service system 110.

As shown in FIG. 1D, and by reference number 145, the service system 110 may receive respective activity times associated with the multiple clients' 105 utilizations of the multiple applications. For example, the service system 110 may utilize the activity service to monitor respective activity times associated with the multiple clients' 105 utilizations of the multiple applications. The respective activity times may be in seconds, minutes, hours, and/or the like. The service system 110 may continuously receive the respective activity times from the multiple clients 105, and/or the application servers 115, may periodically receive the respective activity times from the multiple clients 105 and/or the application servers 115, may receive the respective activity times based on requesting the respective activity times from the multiple clients 105 and/or the application servers 115, and/or the like. In some implementations, the service system 110 may provide the activity times to the application servers 115 so that the applications may track usage by the multiple clients 105.

As further shown in FIG. 1D, and by reference number 150, the service system 110 may receive a notification destined for the identifier. For example, the service system 110 may receive a notification of an incoming call, an incoming text message, an application update, an emergency message, and/or the like from a client 105 not associated with the identifier or the user, one of the application servers 115, a messaging service, an emergency service, and/or the like. Since the service system 110 enables the user to register the identifier (e.g., a telephone number) with a large quantity of applications, the service system 110 may provide the notification to all of the multiple clients 105 via all of the multiple applications. However, providing an incoming notification to a large quantity of clients 105 and/or applications may be unnecessary and overwhelming for the user.

As shown in FIG. 1E, and by reference number 155, the service system 110 may utilize an activity service, of the multiple services, to rank the multiple clients 105 based on the respective activity times and to generate a ranked list. For example, to prevent the user from being overwhelmed with multiple instances of the same notification, the service system 110 may utilize the activity service of the service system 110 to identify the most appropriate clients 105 to receive the notification. In some implementations, the service system 110 may utilize the activity service to rank the multiple clients 105 based on the respective activity times and to generate the ranked list of clients 105. For example, the service system 110 may rank the multiple clients 105 based on frequency of usage, with a most frequently used client 105 being ranked first and a least frequently used client 105 being ranked last. In another example, the service system 110 may rank the multiple clients 105 based on recency of usage, with a most recently used client 105 being ranked first and a least recently used client 105 being ranked last. In another example, the service system 110 may designate one of the multiple clients 105 to receive the notification and one or more other clients 105 to receive the notification based on the ranked list.

As further shown in FIG. 1E, and by reference number 160, the service system 110 may identify one or more of the multiple clients 105 based on the ranked list. For example, the service system 110 may utilize the ranked list of the multiple clients 105 to identify one or more of the multiple clients 105 for receipt of the notification. In some implementations, the service system 110 may identify a designated client 105 to receive the notification, a most frequently used client 105 to receive the notification, a most recently used client 105 to receive the notification, and/or the like.

As shown in FIG. 1F, and by reference number 165, the service system 110 may provide the notification to the identified one or more clients 105. For example, after identifying the one or more of the multiple clients 105 based on the ranked list, the service system 110 may provide the notification to the identified one or more clients 105. The one or more clients 105 may receive the notification and may display the notification to the user. In this way, the user may be assured of receiving the notification and of not being overwhelmed by receiving the notification via all of the multiple clients 105.

FIG. 1G provides an example of utilizing the activity service of the service system 110. For example, as shown at step 1, the service system 110 may receive an incoming call and may provide the incoming call to the push notifications service. As shown at step 2, the push notifications service may request identification of a last active client 105 from the activity service. As shown at step 3, the activity service may identify the last active client 105 and may provide information identifying the last active client 105 to the push notifications service. As shown at step 4, the push notifications service may provide the incoming call to the last active client 105 based on the information identifying the last active client 105.

FIG. 1H provides another example of utilizing the activity service of the service system 110. For example, as shown at step 1, the user may utilize a virtual reality (VR) client 105 to initiate a call to a called party from a video game being played via the VR client 105. The call manager service of the service system 110 may receive the call. As shown at step 2, the call manager service may retrieve activity data associated with the video game from the activity service of the service system 110. The activity data may include data identifying a name of the video game, a quantity of time spent playing the video game, a feature of the video game, and/or the like. As shown at step 3, the call manager service may provide the activity data to the service system 110. As shown at step 4, the service system 110 may include the activity data and the user's caller identifier with the call and may provide the call, with the activity data and the identifier, to a client 105 associated with the called party. In this way, the service system 110 may include activity data in outbound calls (e.g., context-based calling), which enables the client 105 to do things like show from which application the call is being placed and the user's caller identifier.

FIG. 1I provides still another example of utilizing the activity service of the service system 110. For example, as shown at step 1, the active service of the service system 110 may receive activity data associated with a video game (e.g., identifying a name of the video game, a quantity of time spent playing the video game, a feature of the video game, and/or the like). As shown at step 2, the activity service may provide the activity data to the service system 110. As shown at step 3, the service system 110 may update the user's social media account with the activity data associated with the video game. In this way, the user may update the user's status in other third party applications (e.g., social media applications). This may enable the third party applications to display the activity data as a status in the applications, such as “Currently playing basketball in Rec Room-Come Join Me!” or “Currently battling a boss in Video Game.”

In this way, the service system 110 provides numbers-as-a-platform services. For example, the service system 110 may provide a set of agnostic public APIs that enable application developers' tools to allow users of clients 105 to link user identifiers (e.g., telephone numbers) to applications (e.g., an application that can make and receive calls to a telephone number). The service system 110 may change traditional calling since telephone numbers are no longer tied to a personal phone and may enable application developers to integrate native calling into applications. The service system 110 may enable application developers to use telephone numbers in new and creative ways. Thus, the service system 110 may conserve computing resources, networking resources, and/or other resources that would have otherwise been consumed by failing to connect a call with the single user identifier and via an application, failing to scale the single user identifier to provide additional services via the applications, failing to connect multiple clients 105 to an application via the single user identifier, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

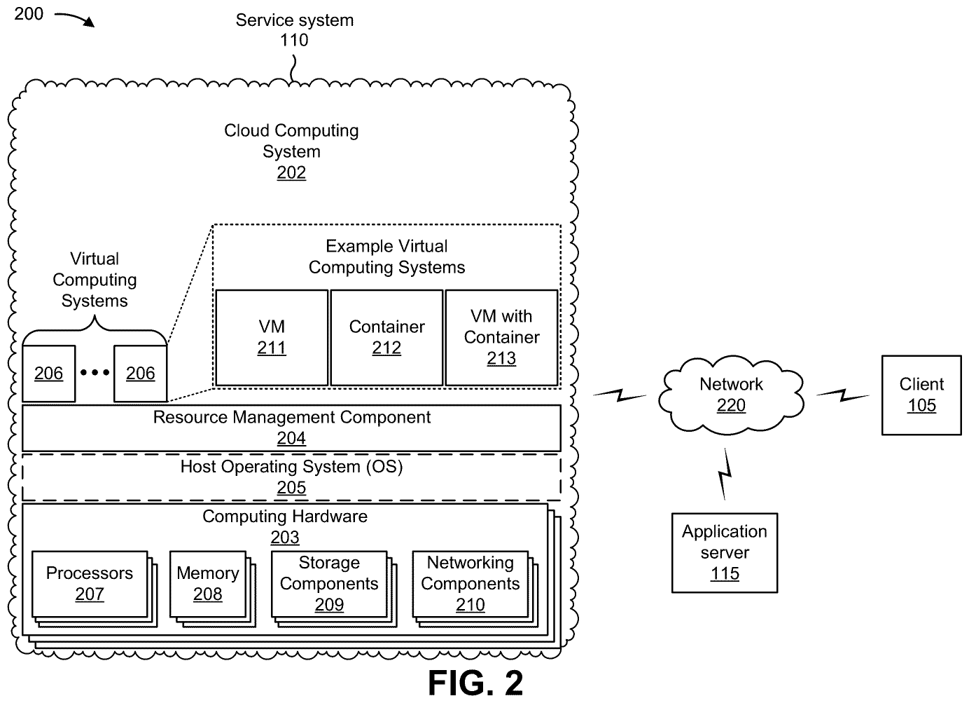

FIG. 2 is a diagram of an example environment 200 in which systems and/or methods described herein may be implemented. As shown in FIG. 2, the environment 200 may include the service system 110, which may include one or more elements of and/or may execute within a cloud computing system 202. The cloud computing system 202 may include one or more elements 203-213, as described in more detail below. As further shown in FIG. 2, the environment 200 may include the client 105, the application server 115, and/or a network 220. Devices and/or elements of the environment 200 may interconnect via wired connections and/or wireless connections.

The client 105 may include one or more devices capable of receiving, generating, storing, processing, and/or providing information, as described elsewhere herein. The client 105 may include a communication device and/or a computing device. For example, the client 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The application server 115 may include one or more devices capable of receiving, generating, storing, processing, providing, and/or routing information, as described elsewhere herein. The application server 115 may include a communication device and/or a computing device. For example, the application server 115 may include a server, such as an application server, a client server, a web server, a database server, a host server, a proxy server, a virtual server (e.g., executing on computing hardware), or a server in a cloud computing system. In some implementations, the application server 115 may include computing hardware used in a cloud computing environment.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

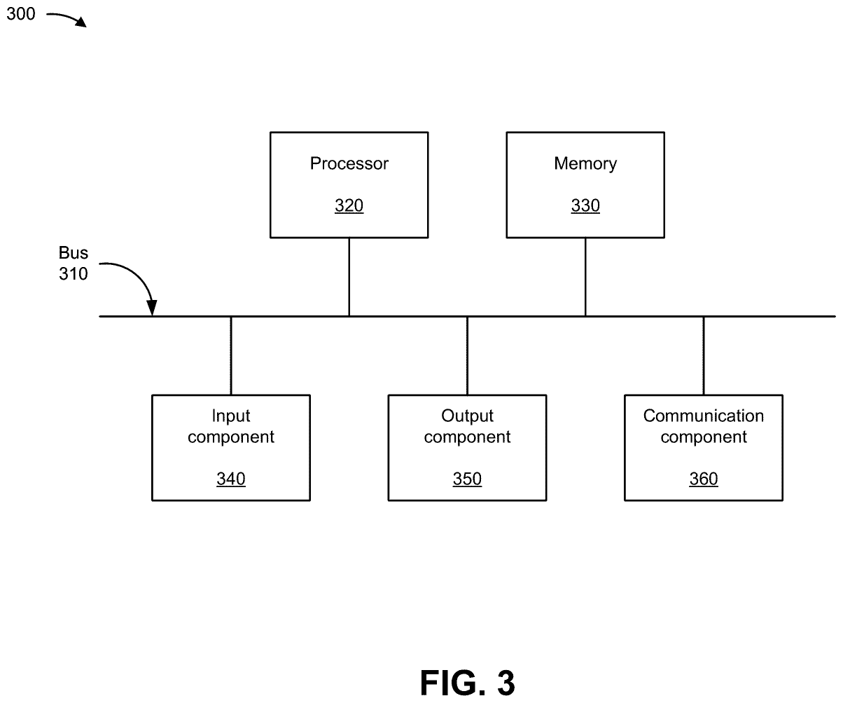

Although the service system 110 may include one or more elements 203-213 of the cloud computing system 202, may execute within the cloud computing system 202, and/or may be hosted within the cloud computing system 202, in some implementations, the service system 110 may not be cloud-based (e.g., may be implemented outside of a cloud computing system) or may be partially cloud-based. For example, the service system 110 may include one or more devices that are not part of the cloud computing system 202, such as the device 300 of FIG. 3, which may include a standalone server or another type of computing device. The service system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the client 105, the service system 110, and/or the application server 115. In some implementations, the client 105, the service system 110, and/or the application server 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

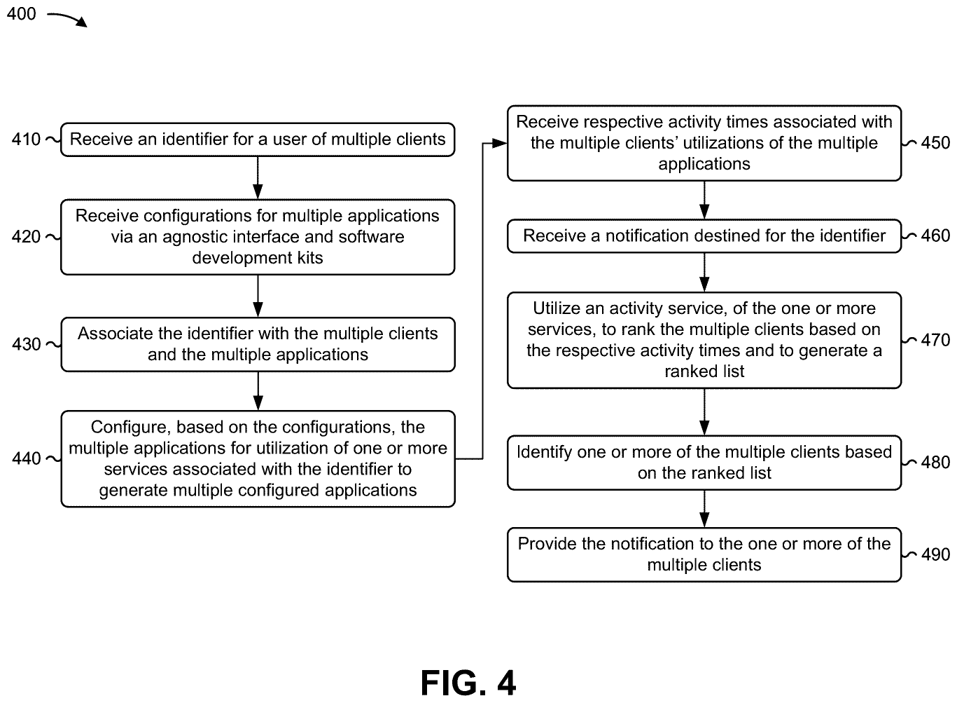

FIG. 4 is a flowchart of an example process 400 for providing numbers-as-a-platform services. In some implementations, one or more process blocks of FIG. 4 may be performed by a device (e.g., the service system 110). In some implementations, one or more process blocks of FIG. 4 may be performed by another device or a group of devices separate from or including the device, such as a client (e.g., the client 105), and/or the like. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving an identifier for a user of multiple clients (block 410). For example, the device may receive an identifier for a user of multiple clients, as described above. In some implementations, the identifier is a telephone number associated with the user.

As further shown in FIG. 4, process 400 may include receiving configurations for multiple applications via an agnostic interface and software development kits (block 420). For example, the device may receive configurations for multiple applications via an agnostic interface and software development kits, as described above. In some implementations, the agnostic interface is an agnostic API capable of communicating with the multiple applications. In some implementations, the software development kits enable the multiple applications to provide the configurations via the agnostic interface.

As further shown in FIG. 4, process 400 may include associating the identifier with the multiple clients and the multiple applications (block 430). For example, the device may associate the identifier with the multiple clients and the multiple applications, as described above.

As further shown in FIG. 4, process 400 may include configuring, based on the configurations, the multiple applications for utilization of one or more services associated with the identifier to generate multiple configured applications (block 440). For example, the device may configure, based on the configurations, the multiple applications for utilization of one or more services associated with the identifier to generate multiple configured applications, as described above. In some implementations, the one or more services include one or more of the activity service, an authentication service, a real-time relay service, a contact management service, a push notification service, or a register service.

As further shown in FIG. 4, process 400 may include receiving respective activity times associated with the multiple clients' utilizations of the multiple applications (block 450). For example, the device may receive respective activity times associated with the multiple clients' utilizations of the multiple applications, as described above.

As further shown in FIG. 4, process 400 may include receiving a notification destined for the identifier (block 460). For example, the device may receive a notification destined for the identifier, as described above.

As further shown in FIG. 4, process 400 may include utilizing an activity service, of the one or more services, to rank the multiple clients based on the respective activity times and to generate a ranked list (block 470). For example, the device may utilize an activity service, of the one or more services, to rank the multiple clients based on the respective activity times and to generate a ranked list, as described above.

As further shown in FIG. 4, process 400 may include identifying one or more of the multiple clients based on the ranked list (block 480). For example, the device may identify one or more of the multiple clients based on the ranked list, as described above.

As further shown in FIG. 4, process 400 may include providing the notification to the one or more of the multiple clients (block 490). For example, the device may provide the notification to the one or more of the multiple clients, as described above.

In some implementations, process 400 includes providing the one or more services for the multiple configured applications. In some implementations, process 400 includes receiving an incoming call destined for the identifier, utilizing the activity service to identify a most recently utilized client of the multiple clients, and providing the incoming call to the most recently utilized client.

In some implementations, process 400 includes receiving, from a client of the multiple clients, a call destined for a called party, utilizing the activity service to retrieve activity information associated with the client, including the activity information and the identifier with the call, and providing the call, with the activity information and the identifier, to the called party. In some implementations, the client is utilizing a video game application and the activity information includes information associated with the video game application. In some implementations, the client is utilizing a social media application and the activity information includes information associated with the social media application.

In some implementations, process 400 includes utilizing the activity service to retrieve activity information associated with a client of the multiple clients, wherein the activity information includes information associated with a first application, and providing the activity information to a second application for display. In some implementations, the first application is a video game application and the second application is a social media application. In some implementations, the client is a most recently utilized client of the multiple clients.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, an identifier for a user of multiple clients;
receiving, by the device, configurations for multiple applications via an agnostic interface and software development kits;
associating, by the device, the identifier with the multiple clients and the multiple applications;
configuring, by the device and based on the configurations, the multiple applications for utilization of one or more services associated with the identifier to generate multiple configured applications;
receiving, by the device, respective activity times associated with the multiple clients' utilizations of the multiple applications;
receiving, by the device, a notification destined for the identifier;
utilizing, by the device, an activity service, of the one or more services, to rank the multiple clients based on the respective activity times and to generate a ranked list;
identifying, by the device, one or more of the multiple clients based on the ranked list; and
providing, by the device, the notification to the one or more of the multiple clients.

2. The method of claim 1, wherein the identifier is a telephone number associated with the user.

3. The method of claim 1, wherein the agnostic interface is an agnostic application programming interface capable of communicating with the multiple applications.

4. The method of claim 1, wherein the software development kits enable the multiple applications to provide the configurations via the agnostic interface.

5. The method of claim 1, further comprising:
providing the one or more services for the multiple configured applications.

6. The method of claim 1, wherein the one or more services include one or more of:
the activity service,
an authentication service,
a real-time relay service,
a contact management service,
a push notification service, or
a register service.

7. The method of claim 1, further comprising:
receiving an incoming call destined for the identifier;
utilizing the activity service to identify a most recently utilized client of the multiple clients; and
providing the incoming call to the most recently utilized client.

8. A device, comprising:
one or more processors configured to:
receive an identifier for a user of multiple clients,
wherein the identifier is a telephone number associated with the user;
receive configurations for multiple applications via an agnostic interface and software development kits;
associate the identifier with the multiple clients and the multiple applications;
configure, based on the configurations, the multiple applications for utilization of one or more services associated with the identifier to generate multiple configured applications;
receive respective activity times associated with the multiple clients' utilizations of the multiple applications;
receive a notification destined for the identifier;
utilize an activity service, of the one or more services, to rank the multiple clients based on the respective activity times and to generate a ranked list;
identify one or more of the multiple clients based on the ranked list; and
provide the notification to the one or more of the multiple clients.

9. The device of claim 8, wherein the one or more processors are further configured to:
receive, from a client of the multiple clients, a call destined for a called party;
utilize the activity service to retrieve activity information associated with the client;
include the activity information and the identifier with the call; and
provide the call, with the activity information and the identifier, to the called party.

10. The device of claim 9, wherein the client is utilizing an application and the activity information includes information associated with the e application.

11. The device of claim 9, wherein the client is utilizing a video game application or a social media application and the activity information includes information associated with either the video game application or the social media application.

12. The device of claim 8, wherein the one or more processors are further configured to:
utilize the activity service to retrieve activity information associated with a client of the multiple clients,
wherein the activity information includes information associated with a first application; and
provide the activity information to a second application for display.

13. The device of claim 12, wherein the first application is a video game application and the second application is a social media application.

14. The device of claim 12, wherein the client is a most recently utilized client of the multiple clients.

15. A non-transitory computer-readable medium storing a set of instructions, the set of instructions comprising:
one or more instructions that, when executed by one or more processors of a device, cause the device to:
receive an identifier for a user of multiple clients;
receive configurations for multiple applications via an agnostic interface and software development kits,
wherein the agnostic interface is an agnostic application programming interface capable of communicating with the multiple applications;
associate the identifier with the multiple clients and the multiple applications;
configure, based on the configurations, the multiple applications for utilization of one or more services associated with the identifier to generate multiple configured applications;
receive respective activity times associated with the multiple clients' utilizations of the multiple applications;
receive a notification destined for the identifier;
utilize an activity service, of the one or more services, to rank the multiple clients based on the respective activity times and to generate a ranked list;
identify one or more of the multiple clients based on the ranked list; and
provide the notification to the one or more of the multiple clients.

16. The non-transitory computer-readable medium of claim 15, wherein the one or more instructions further cause the device to:
provide the one or more services for the multiple configured applications.

17. The non-transitory computer-readable medium of claim 15, wherein the one or more instructions further cause the device to:
receive an incoming call destined for the identifier;
utilize the activity service to identify a most recently utilized client of the multiple clients; and
provide the incoming call to the most recently utilized client.

18. The non-transitory computer-readable medium of claim 15, wherein the one or more instructions further cause the device to:
receive, from a client of the multiple clients, a call destined for a called party;
utilize the activity service to retrieve activity information associated with the client;
include the activity information and the identifier with the call; and
provide the call, with the activity information and the identifier, to the called party.

19. The non-transitory computer-readable medium of claim 18, wherein the client is utilizing a particular application and the activity information includes information associated with the particular application.

20. The non-transitory computer-readable medium of claim 15, wherein the one or more instructions further cause the device to:
utilize the activity service to retrieve activity information associated with a client of the multiple clients,
wherein the activity information includes information associated with a first application; and
provide the activity information to a second application for display.
